(19) United States
(12) Patent Application Publication
(10) Pub. No.: US 2025/0312857 A1
(43) Pub. Date: Oct. 9, 2025

(54) UNIVERSAL MILLING MACHINE ASSEMBLY TOOL

(71) Applicant: Michael Kettner, Sheboygan, WI (US)

(72) Inventor: Michael Kettner, Sheboygan, WI (US)

(21) Appl. No.: 19/243,668

(22) Filed: Jun. 19, 2025

Related U.S. Application Data
(63) Continuation of application No. 18/603,559, filed on Mar. 13, 2024.

(51) Int. Cl. B23C 3/16

(52) U.S. Cl. CPC B23C 3/16

(57) ABSTRACT

A universal milling assembly tool is disclosed. The tool includes a tool body frame; a robotic arm assembly base attached to the tool body frame; robotic arm assembly base couplers positioned on the robotic arm assembly base; articulating robotic arm assemblies connected to the robotic arm assembly base couplers, where the robotic arm assemblies include an attachment end for each of the one or more robotic arm assemblies to the robotic arm assembly base couplers; robotic arm assembly connecting rods connected to each other through articulating joints along the robotic arm assemblies; an attachment end for each of the robotic arm assemblies, and interchangeable robotic arm milling assembly machining tools attachable to the attachment end for each of the robotic arm assemblies.

### CROSS REFERENCES OF RELATED APPLICATIONS

This application is a continuation of U.S. application Ser. No. 18/603,559, filed on Mar. 13, 2024, which is incorporated herein by reference in its entirety.

### BACKGROUND

### Technical Field

This disclosure relates to tool machining systems. In particular, the disclosure relates to, and without limitation, to a universal milling machining tool with movable robotic arms and interchangeable tools that can be placed on each arm.

Robotic assembly tools are known in the art.

U.S. Pat. No. 5,816,736 describes a robot arm assembly.

U.S. Pat. No. 11,198,215 describes a robotic arm.

KR 101987823 describes a dual arm robot system.

US 2016/0375580 describes a robot system and robot control method.

JP 2018/69342 describes a control device, robot, and robot system.

WO 2016158614 describes a robot arm affixation device and robot.

WO 2016119829 describes a multiple arm robot system and method for operating a multiple arm robot system.

While multiple arm robotic tool systems are known in the art, these systems are limited in the interchangeability of arm tip tools. Complicated steps must be taken to replace a tool tip, or the operator may need to use a different tool assembly altogether. In addition, conventional milling tool systems are outdated and not robust to adapt very well to oscillation of the machined part, causing errors in machining and fabrication of the part as a result.

Therefore, a need exists for a universal milling machine assembly tool.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

A universal milling machine assembly tool is disclosed, according to an aspect of the disclosure. The universal milling machine assembly tool includes a tool body frame; a robotic arm assembly base positioned in communication with the tool body frame; one or more quick-connect robotic arm assembly base couplers, each of the one or more robotic arm assembly base couplers positioned in communication with and arrayed about the robotic arm assembly base; one or more robotic arm assemblies, in articulating communication with the one or more robotic arm assembly base couplers with one or more pivotably attached base coupler joints. In an aspect, the one or more robotic arm assemblies include a proximal attachment end for each of the one or more robotic arm assemblies; one or more robotic arm assembly connecting rods, where a first robotic arm assembly connecting rod is in communication with the proximal attachment end for each of the one or more robotic arm assemblies; one or more articulating joints positioned between each of the one or more robotic arm assembly connecting rods, where the one or more articulating joints allow the one or more robotic arm assembly connecting rods a defined range of motion in space about the one or more articulating joints, a distal attachment end for each of the one or more robotic arm assemblies, where the distal attachment end is in communication with a distal robotic arm assembly connecting rod of the one or more robotic arm assembly connecting rods; and one or more robotic arm assembly milling tools, where the one or more robotic arm assembly milling tools are interchangeably attachable to the distal attachment end for each of the one or more robotic arm assemblies and where the one or more robotic arm assembly milling tools are configured to machine process a work piece and the one or more robotic arm assembly milling tools are configured to adapt to an oscillation or apply an oscillation of the work piece during the machine process, where the oscillation of either the work piece or the one or more robotic arm assembly milling tools comprises a synthesis oscillation or a waveform oscillation, linear motion, reciprocating motion, circular/orbital motion, Brownian motion, curvilinear motion along multiple axes, oscillatory motion, simultaneous motions (when two or more above listed motions acts simultaneously, vibratory motion, motion oscillation, wave form synthesis, wave manipulation, floating motion and/or a combination thereof, or any type of waveform created by a user or artificial intelligence or a combination of both.

In an aspect, the universal milling machine assembly tool may include one or more robotic arm assembly attachment tools, where the one or more robotic arm assembly attachment tools are interchangeably attachable to the distal attachment end for each of the one or more robotic arm assemblies, where the one or more robotic arm assembly attachment tools comprise at least one of a robotic arm attachment tool, a milling tool, an electrical discharge machining tool, a material printing tool, an absolute zero tolerance robotic holding arm tool, a welding attachment tool, a flat surface tool, a fastener assembly tool, a robotic hand, a humanoid-type robot hand to imitate a human hand adapted to operate a tool comprising a hammer, a drill, a shovel, a pickaxe, a steered vehicle, a construction vehicle, aerial vehicles, where the tool is configured to oscillate in a waveform or synthesis or a combination thereof, and further comprising a sensor to obtain zero tolerance, where the one or more robotic arm assembly attachment tools comprise a tip and a size for an intended purpose.

In an aspect, the one or more robotic arm assembly attachment tools may include a robotic arm attachment coupler, where the robotic arm attachment coupler is configured to attach to the distal attachment end; a robotic hand base in pivotable communication with the robotic arm attachment coupler; one or more robotic actuating fingers in actuating communication with the robotic hand base, where the one or more robotic actuating fingers include one or more robotic finger tips positioned at a distal end location of one of the one or more robotic actuating fingers; and one or more robotic finger actuating joints in actuating communication with one or more robotic finger connecting spurs, the one or more robotic finger connecting spurs further comprising a proximal finger connecting spur in actuating communication with the robotic hand base; a distal finger connecting spur in actuating communication with one of the one or more robotic finger actuating joints and in actuating communication with one of the one or more robotic finger tips, the one or more robotic finger tips configured to operate in a vice mode or manual mode.

In an aspect, the one or more robotic finger tips may include an indented gripping pattern disposed upon a distal end of one of the one or more robotic finger tips, the indented gripping pattern configured to securely hold a work piece during processing.

In an aspect, the indented gripping pattern includes an intersecting cross-shaped pattern indented into the distal end of the one of the one or more robotic finger tips and further comprises an indentation on each side face of the one or more robotic finger tips, the indentation extending with a maximum lateral width from the distal end of the one or more robotic finger tips to a minimum lateral width at a point along each side face of the one or more robotic finger tips.

In an aspect, the indentation comprises at least one of a V-shaped indentation, flat, with crossed V-shapes in different directions or checkered patterns.

In aspect, the milling tool is configured to machine process a work piece and the machining tool is configured to adapt to oscillation of the work piece during the machine process, where the oscillation of the work piece comprises a synthesis oscillation or a waveform oscillation, linear motion, reciprocating motion, circular/orbital motion, Brownian motion, curvilinear motion along multiple axes, oscillatory motion, simultaneous motions (when two or more above listed motions acts simultaneously, vibratory motion, motion oscillation, wave form synthesis, wave manipulation, floating motion and/or a combination thereof, or any type of waveform created by a user or artificial intelligence or a combination of both.

In an aspect, the material printing tool is configured to apply additive printing material to a work piece and the material printing tool is configured to adapt to oscillation of the work piece during an additive printing process, where the oscillation comprises linear motion, reciprocating motion, circular/orbital motion, Brownian motion, curvilinear motion along multiple axes, oscillatory motion, simultaneous motions (when two or more above listed motions acts simultaneously, vibratory motion, motion oscillation, wave form synthesis, wave manipulation, floating motion and/or a combination thereof.

A method for machining a work piece by a universal milling machine assembly tool is disclosed. The method includes providing universal milling machine assembly tool, the universal milling machine assembly tool comprising one or more one or more articulating robotic arm assemblies, where the one or more one or more articulating robotic arm assemblies comprise one or more robotic arm assembly connecting rods connected to each other through one or more articulating joints along the one or more robotic arm assemblies; an attachment end for each of the one or more robotic arm assemblies, and one or more interchangeable robotic arm assembly attachment tools attachable to the attachment end for each of the one or more robotic arm assemblies; providing a work piece to be machined by the universal milling machine assembly tool; and applying the one or more interchangeable robotic arm assembly attachment tools to process the work piece. The universal milling machine assembly tool is capable of accommodating different types of motion of the workpiece, including linear motion, reciprocating motion, circular/orbital motion, Brownian motion (depending on the scale of the workpiece and the universal milling machine assembly tool), curvilinear motion along multiple axes, oscillatory-(swinging from side to side), simultaneous motions (when two or more above listed motions acts simultaneously, vibratory motion, motion oscillation, wave form synthesis, wave manipulation, floating motion and/or combinations thereof. The motions acceptable to universal milling machine assembly tool may be programmed ahead of machining or synthesized in real time as the workpiece is being processed. In an aspect, the universal milling machine assembly tool may be programmed to apply different types of finishes to a work piece, depending on a user's application. In an aspect, the finishes are oscillations, waveform synthesized or waveform or even “polka music” waveform or rock'n′roll type music or could have a float function to float freely. Different levels of capability and functionality may be included in the universal milling machine assembly tool depending on the cost function and desired applications required by a user. The universal milling machine assembly tool could have all the capabilities, some of the capabilities or none of the capabilities depending on the user preference or complexity of the equipment that was bought.

Other systems, methods, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 is a view of a first aspect of a universal milling machine assembly tool, according to the disclosure.

FIG. 2 is a view of a second aspect of a universal milling machine assembly tool, according to the disclosure.

FIG. 3 is a view of a third aspect of a universal milling machine assembly tool, according to the disclosure.

FIG. 4 is a view of a robotic arm attachment tool, according to the disclosure.

FIG. 5 is a view of an end tip of a robotic arm attachment tool, according to the disclosure.

FIG. 6 is a view of aspects of universal robot assembly arms, according to the disclosure.

FIG. 7 is a view of an aspect of a universal milling machine assembly tool, according to the disclosure.

FIG. 8 is a view of a grinding tool attachment for the universal milling machine assembly tool, according to the disclosure.

FIG. 9 is an example flow chart of acts taken for machining a work piece by a universal milling machine assembly tool, according to the disclosure.

FIG. 10A is a view of an aspect of the universal milling machine assembly tool with a knee kicker.

FIG. 10B is a view of an aspect of the universal milling machine assembly tool with a knee kicker.

FIG. 10C is a view of an aspect of the universal milling machine assembly tool with a knee kicker.

FIG. 11A is a view of an aspect of the universal milling machine assembly tool.

FIG. 11B is a view of an aspect of the universal milling machine assembly tool with an oscillator.

FIG. 11C is a view of an aspect of the universal milling machine assembly tool with an oscillator.

### DETAILED DESCRIPTION

A universal milling machine assembly tool is disclosed. The tool includes a tool body frame; a robotic arm assembly base attached to the tool body frame; robotic arm assembly base couplers positioned on the robotic arm assembly base; articulating robotic arm assemblies connected to the robotic arm assembly base couplers, where the robotic arm assemblies include an attachment end for each of the one or more robotic arm assemblies to the robotic arm assembly base couplers; robotic arm assembly connecting rods connected to each other through articulating joints along the robotic arm assemblies; an attachment end for each of the robotic arm assemblies, and interchangeable robotic arm assembly attachment tools attachable to the attachment end for each of the robotic arm assemblies.

Various aspects of the present disclosure will be described in detail with reference to the drawings, wherein like reference numerals represent like parts and assemblies throughout the several views. Reference to various aspects does not limit the scope of the disclosure, which is limited only by the scope of the claims attached hereto. Additionally, any examples set forth in this specification are not intended to be limiting and merely set forth some of the many possible aspects for the claimed disclosure.

In describing aspects of the present disclosure, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The terms “communicate,” or “communication” refer to any component(s) connecting with any other component(s) in any combination, whether through direct physical connection, intermediary physical connection or wirelessly connected for the purpose of the connected components to communicate, interact, transfer energy or motion and/or transfer data to and from any components and/or control any settings.

For the purposes of the disclosure, though describing an example definition and not a limiting definition, computer numerical control (“CNC”) refers to, in manufacturing, the control of a device, particularly machine tools, by direct input of data from a computer program. It is a principal element of computer-integrated manufacturing. CNC is also essential to the operation of industrial robots. CNC systems often receive their instructions from computer-aided design (CAD) programs. Two basic types of CNC systems are point-to-point, in which a device is programmed to perform a series of motions with fixed starting and stopping points, and continuous-path, in which a point-to-point programmed device has sufficient memory to be “aware” of its former actions and their results and to act in accordance with this information.

For the purposes of the disclosure, though describing an example definition and not a limiting definition, Welding is a fabrication process whereby two or more parts are fused together by means of heat, pressure or both forming a joint as the parts cool. Welding is usually used on metals and thermoplastics but can also be used on wood. The completed welded joint may be referred to as a weldment. Some materials require the use of specific processes and techniques. A number are considered “unweldable,” The parts that are joined are known as a parent material. The material added to help form the joint is called filler or consumable. The form of these materials may see them referred to as parent plate or pipe, filler wire, consumable electrode (for arc welding), etc. Consumables are usually chosen to be similar in composition to the parent material, thus forming a homogenous weld, but there are occasions, such as when welding brittle cast irons, when a filler with a very different composition and, therefore, properties is used. These welds are called heterogeneous. The completed welded joint may be referred to as a weldment. The four main types of welding are: Gas Metal Arc Welding (GMAW/MIG), Gas Tungsten Arc Welding (GTAW/TIG), Shielded Metal Arc Welding (SMAW), and Flux Cored Arc Welding (FCAW).

For the purposes of this disclosure, though describing an example definition and not a limiting definition, “additive manufacturing” (“AM”) or “additive layer manufacturing” (“ALM”) refers to the industrial production name for 3D printing, a computer controlled process that creates three dimensional objects by depositing materials, usually in layers.

Using computer aided design (CAD) or 3D object scanners, additive manufacturing allows for the creation of objects with precise geometric shapes. These are built layer by layer, as with a 3D printing process, which is in contrast to traditional manufacturing that often requires machining or other techniques to remove surplus material. Some examples of AM include Binder Jetting—This technique uses a 3d printing style head moving on x, y and z axes to deposit alternating layers of powdered material and a liquid binder as an adhesive. There are several types of AM.

Directed Energy Deposition—Direct energy deposition additive manufacturing can be used with a wide variety of materials including ceramics, metals and polymers. A laser, electric arc or an electron beam gun mounted on an arm moves horizontally melting wire, filament feedstock or powder to build up material as a bed moves vertically.

Material Extrusion—This common AM process uses spooled polymers which are either extruded or drawn through a heated nozzle which is mounted on a movable arm. This builds melted material layer by layer as the nozzle moves horizontally and the bed moves vertically. The layers adhere through temperature control or chemical bonding agents.

Powder Bed Fusion—Powder bed fusion encompasses a variety of AM techniques including direct metal laser melting (DMLM), direct metal laser sintering (DMLS), electron beam melting (EBM), selective laser sintering (SLS) and selective heat sintering (SHS). Electron beams, lasers or thermal print heads are used to melt or partially melt fine layers of material after which excess powder is blasted away. In an aspect, an additive could be added to powder to crystalize or make the powder mixture a solid. It could also be 3D-printed under water or maybe in a liquid or a form if needed. In an aspect, the 3D printing technology could be as disclosed and incorporated by reference in https://3dprint.com/305699/rip-3d-printing-long-live-am/, where the tank also could be used for putting graphics or colors on objects for decoration such as water transfer printing. The tank could be used for applying materials like chrome or stripping material off.

Sheet Lamination—Sheet lamination can be split into two technologies; laminated object manufacturing (LOM) and ultrasonic additive manufacturing (UAM). Laminated object manufacturing is suited to creating items with visual or aesthetic appeal and uses alternate layers of paper and adhesive. UAM uses ultrasonic welding to join thin metal sheets; a low energy, low temperature process, UAM can be used with various metals such as aluminum, stainless steel and titanium.

Vat Polymerization—This process uses a vat of liquid resin photopolymer to create an object layer by layer. Mirrors are used to direct ultraviolet light which cures the successive layers of resin through photopolymerization.

Wire Arc Additive Manufacturing (Now known as Directed Energy Deposition-Arc (DED-arc))—Wire arc additive manufacturing uses arc welding power sources and manipulators to build 3D shapes through arc deposition. This process commonly uses wire as a material source and follows a predetermined path to create the desired shape. This method of additive manufacture is usually performed using robotic welding equipment.

In the following description, numerous specific details are set forth to clearly describe various specific aspects disclosed herein. One skilled in the art, however, will understand that the presently claimed disclosure may be practiced without all of the specific details discussed below. In other instances, well known features have not been described so as not to obscure the disclosure. As described herein, the term “pivotally connected” shall be used to describe a situation wherein two or more identified objects are joined together in a manner that allows one or both of the objects to pivot, and/or rotate about or in relation to the other object in either a horizontal or vertical manner. As described herein, the term “removably coupled” and derivatives thereof shall be used to describe a situation wherein two or more objects are joined together in a non-permanent manner so as to allow the same objects to be repeatedly joined and separated. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. In addition, it should be understood that aspects of the disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one aspect, the electronic based aspects of the disclosure may be implemented in software. As such, it should be noted that a plurality of hardware and software-based devices, as well as a plurality of different structural components may be utilized to implement the disclosure. Furthermore, and as described in subsequent paragraphs, the specific mechanical configurations illustrated in the drawings are intended to exemplify aspects of the disclosure and that other alternative mechanical configurations are possible.

The disclosed tool system provides a multi-functional, adaptable, configurable and interchangeable industrial machine with many modes of operation. In one aspect of the disclosure, the disclosed universal industrial machine may be a milling machine.

As known in the art, a milling machine conventionally includes a base, a column extending from the base, a ram extending from the column, and a head. A motor may be located on the head to drive a spindle attached to the ram. The spindle can house different milling attachments, to machine a workpiece located on a table below the spindle and attached to the column. However, the conventional milling machine is outdated and unable to accommodate different types of motion of a workpiece to be machined.

In the context of this disclosure, milling machines facilitate in removal of metal pieces or any substance through a rotating cutter. The rotation of the cutter takes place at high speed, which helps it cut through metal efficiently. Furthermore, these cutters have cutting edges that play a vital role in cutting materials. These types of processes are performed on various types of milling machines.

There are several types of milling machines known to those of skill in the art, such as Horizontal or Plain Milling Machines, Vertical Milling Machines, Universal Milling Machines, Simplex Milling Machines, Duplex Milling Machines, Triplex Milling Machines, Rotary Table Milling Machines, Tracer Controlled Milling Machines, CNC Milling Machines, Drum Milling Machines, Turret Milling Machines, C-Frame Milling Machines, Tracer Controlled Milling Machines, Bed Type Milling Machines and Column Milling Machines. Details regarding these non-limiting examples of milling machines are understood by a person of ordinary skill in the art and described in conventional sources, such as https://www.engineeringchoice.com/types-of-milling-machines/, the entirety of which is incorporated by reference.

Milling machines can hold more than one cutter at a time. It is the most important machines found in a workshop, allowing operations with high accuracy. It has a high rate of metal removal compared to other similar machines, such as a shaper, planners, and lathe machines.

These machines are famous for their better surface finishing and excellent accuracy, making them a necessity for production work. Applications of milling machines and attachments of milling machine elements to the disclosed universal industrial machine include 5-axis milling operations, lathe applications, mobile milling applications, Bridgeport-type and benchtop milling applications. Interchangeable milling tool attachments and application tools may be automated for use with disclosed universal industrial machine. Examples include rotary tool assortments to provide tool attachments for the milling applications of the universal industrial machine.

In an aspect, the disclosed universal milling machine assembly tool may be a milling machine with or without a universal assembly tool.

In an aspect, the disclosed universal milling machine assembly tool could be completely manual like a commercial Bridgeport milling machine or any manual milling machine, including the milling machines known in the art as described herein.

In an aspect of the disclosure, the universal industrial machine may include a plurality of clamping devices to clamp workpieces to a table or worksite. Fixture clamps are known to one of skill in the art and may be selected for a given workpiece size, shape, orientation or other aspects of a workpiece needing to be clamped to a worksite for machining. In an aspect, the clamping device may be a component of a tool holder for the universal industrial machine. In an aspect, the tool holder could have fittings in it so that it could feed a tool that has ports in it for cooling and/or cutting/grinding or other applications. Both the top and the base holder of the tool holder would be able to do all the movements required to machine a workpiece, such that they could turn on each individually or use multiple at the same time or individually, depending on the quality of the finish needed.

Conventionally, machining tools, including robotic-assisted machining, manufacturing and processing are not well-equipped to allow oscillation of the machine itself and/or the holder of a workpiece. The present disclosure provides a universal robot tool with interchangeable tools attachable to one or more robotic arm assemblies.

In an aspect of the disclosure, the tool includes a tool body frame; a robotic arm assembly base attached to the tool body frame; robotic arm assembly base couplers positioned on the robotic arm assembly base; articulating robotic arm assemblies connected to the robotic arm assembly base couplers, where the robotic arm assemblies include an attachment end for each of the one or more robotic milling machine arm assemblies to the robotic arm assembly base couplers; robotic arm assembly connecting rods connected to each other through articulating joints along the robotic milling machine arm assemblies; an attachment end for each of the robotic arm assemblies, and interchangeable robotic arm assembly milling attachment tools attachable to the attachment end for each of the robotic milling machine arm assemblies. In an aspect, robotic arm assembly attachment tools may include milling tools for machine processing a work piece held in position by a work piece holder. In an aspect, the work piece and/or the robotic arm assembly milling attachment tools may oscillate or apply an oscillation to each other. In an aspect, the robotic arm assembly attachment tools are configured to adapt to an oscillation or apply an oscillation of the work piece during the machine process, where the oscillation of either the work piece or the one or more robotic arm assembly machining tools comprises a synthesis oscillation or a waveform oscillation, linear motion, reciprocating motion, circular/orbital motion, Brownian motion, curvilinear motion along multiple axes, oscillatory motion, simultaneous motions (when two or more above listed motions acts simultaneously, vibratory motion, motion oscillation, wave form synthesis, wave manipulation, floating motion and/or a combination thereof, or any type of waveform created by a user or artificial intelligence or a combination of both.

In an aspect, the tool includes at least one of a robotic arm attachment tool, a machining tool, a milling tool, a material printing tool, an absolute zero tolerance robotic holding arm tool, a welding attachment tool, a flat surface tool or a fastener assembly tool. In a further aspect, the tool could be configured to be responsive in determining where “zero” is to effect an absolute zero tolerance. Other machining and manufacturing tools may be substituted without deviating from the scope of the disclosure.

The following briefly describes the aspects of the disclosure in order to provide a basic understanding of some aspects of the disclosure. This brief description is not intended as an extensive overview. It is not intended to identify key or critical elements, or to delineate or otherwise narrow the scope. Its purpose is merely to present some concepts in a simplified form as a prelude to the more detailed description that is presented later.

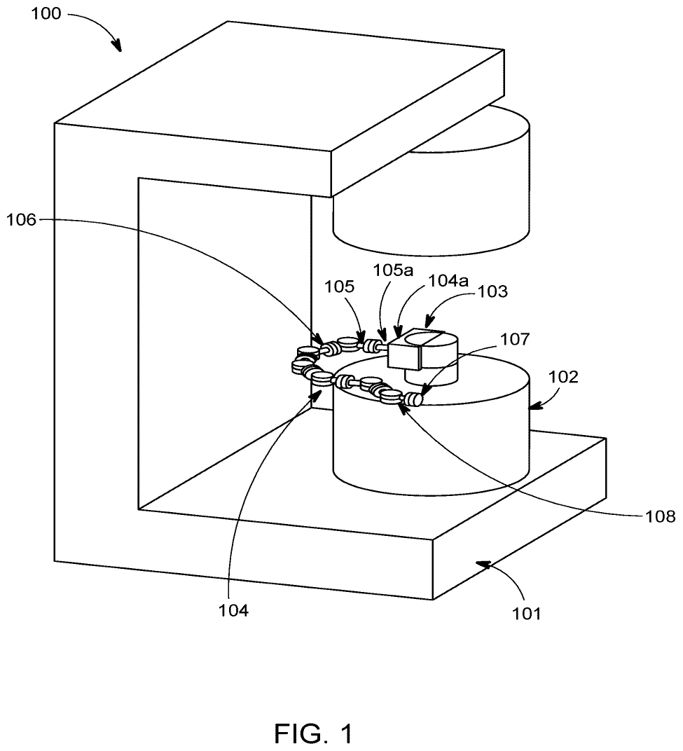

FIG. 1 is a view of a first aspect of a universal milling machine assembly tool 100, according to the disclosure. The universal milling machine assembly tool 100 includes a tool body frame 101. The tool body frame 101 may be of sufficient mass and proportions to support the universal milling machine assembly tool 100. The tool body frame 101 may be made of steel or other durable material. In an aspect, the universal milling machine assembly tool 100 includes a robotic arm assembly base 102 positioned in communication with the tool body frame 101. As shown in FIG. 1, the robotic arm assembly base 102 is positioned near the bottom of the tool base frame 101. However, the robotic arm assembly base 102 may be positioned near the top of the tool body frame 101, or may be duplicated near the top of the tool body frame 101. In an aspect, the robotic arm assembly base 102 may be stationary in relationship to the tool body frame 101. In an aspect, the robotic arm assembly base 102 may be movable in relationship to the tool body frame 101, such as moving linearly in horizontal directions, vertically or rotating about an axis defined by the center of the robotic arm assembly base 102. It is understood that the position of the robotic arm assembly base 102 may be located as needed, and not only as depicted in the aspect shown in FIG. 1.

The universal milling machine assembly tool 100 is capable of accommodating different types of motion of the workpiece, including linear motion, reciprocating motion, circular/orbital motion, Brownian motion (depending on the scale of the workpiece and the universal milling machine assembly tool 100), curvilinear motion along multiple axes, oscillatory—(swinging from side to side), simultaneous motions (when two or more above listed motions acts simultaneously), vibratory motion, motion oscillation, wave form synthesis, wave manipulation and combinations thereof. The motions acceptable to universal milling machine assembly tool 100 may be programmed ahead of machining or synthesized in real time as the workpiece is being processed.

The clamping of any of the current milling machines could or could not be used with the different kinds of motion described above dependently or independently. The milling head of the universal milling assembly tool 100 may also be capable of the different kinds of motion described above.

The universal milling machine assembly tool 100 includes one or more robotic arm assembly base couplers 103, where each of the one or more robotic arm assembly base couplers 103 is positioned in communication with and arrayed about the robotic arm assembly base 102. There may be only one robotic arm assembly base coupler 103 if only the use of one robotic arm assembly is required. In an aspect, there may be multiple robotic arm assembly base couplers 103 if more than one robotic arm assembly is required.

The universal milling machine assembly tool 100 includes one or more robotic arm assemblies 104, in articulating communication with the one or more robotic arm assembly base couplers 103. The one or more robotic arm assemblies 104 may be pivotably attached to one or more base coupler joints. The one or more robotic arm assemblies 104 may include a proximal attachment end 104a for each of the one or more robotic arm assemblies 104. The one or more robotic arm assemblies 104 may include one or more robotic arm assembly connecting rods 105, where a first robotic arm assembly connecting rod 105a is in communication with the proximal attachment end 104a for each of the one or more robotic arm assemblies 104.

The one or more robotic arm assemblies 104 may include one or more articulating joints 106 positioned between each of the one or more robotic arm assembly connecting rods 105, where the one or more articulating joints 106 allow the one or more robotic arm assembly connecting rods 105 a defined range of motion in space about the one or more articulating joints 106. The defined range of motion in space may be some 3D range of motion about the one or more articulating joints 106 to allow a larger range of motion for the robotic arm assembly 104.

A distal attachment end 107 is provided for each of the one or more robotic arm assemblies 104, where the distal attachment end 107 is in communication with a distal robotic arm assembly connecting rod 108 of the one or more robotic arm assembly connecting rods 105.

In an aspect of the disclosure, the one or more robotic arm assembly connecting rods 105 may be hydraulic actuators, universal joint-coupled rods, electrical, such as a screw driven actuator, pneumatic or fluid or other power application or other extending connecting mechanisms.

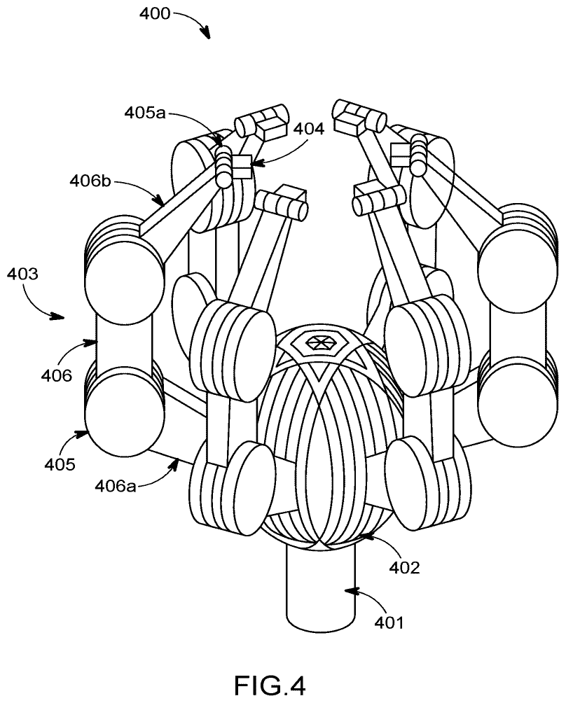

The one or more robotic arm assemblies 104 includes one or more robotic arm assembly attachment tools, where the one or more robotic arm assembly attachment tools are interchangeably attachable to the distal attachment end 107 for each of the one or more robotic arm assemblies 104. The one or more robotic arm assembly attachment tools will be described in more detail in FIGS. 4-8.

In an aspect of the disclosure, the universal milling machine assembly tool 100 may include one or more sensors in communication with the universal milling machine assembly tool 100. The sensors may include motion detection, positional, temperature, heat, humidity, image and facial recognition and other sensors configured to examine the work piece in process by the universal milling machine assembly tool 100. In an aspect, the universal milling machine assembly tool 100 may include an automatic inspection tool for work pieces, including scales, optical recognition and other sensors for quality control and inspection. In an aspect of the disclosure, the universal milling machine assembly tool 100 may be regulated by a clock system, which may be digital and/or synchronized with an external source such as a wireless signal, GPS system or atomic clock system. In an aspect of the disclosure, the universal milling machine assembly tool 100 may be regulated in real-time.

In an aspect of the disclosure, the components of the universal milling machine assembly tool 100, such as the one or more robotic arm assemblies 104, may be distributed across multiple universal milling machine assembly tools 100 and/or configured as in an assembly line process. In an aspect, the one or more robotic arm assemblies 104 are self-cleaning.

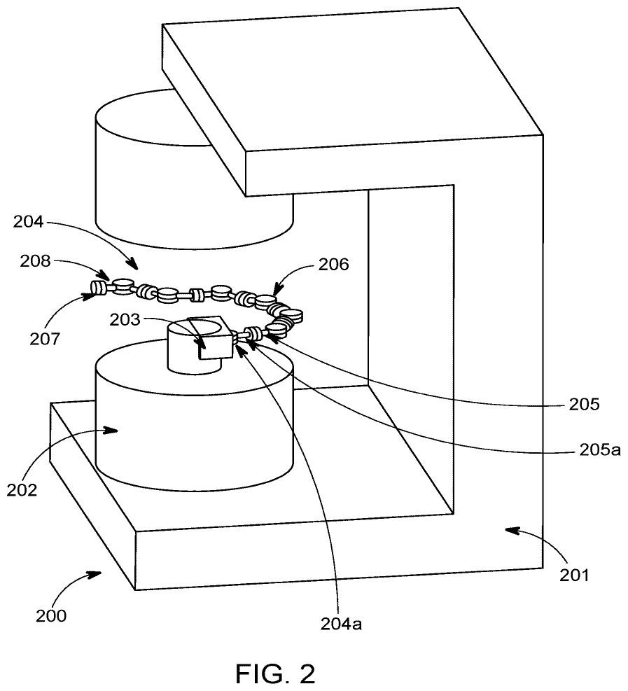

FIG. 2 is a view of a second aspect of a universal milling machine assembly tool 200, according to the disclosure. FIG. 2 illustrates a reverse view of the universal milling machine assembly tool 100. The universal milling machine assembly tool 200 includes a tool body frame 201. The tool body frame 201 may be of sufficient mass and proportions to support the universal milling machine assembly tool 200. The tool body frame 201 may be made of steel or other durable material. In an aspect, the universal milling machine assembly tool 201 includes a robotic arm assembly base 202 positioned in communication with the tool body frame 201. As shown in FIG. 2, the robotic arm assembly base 202 is positioned near the bottom portion of the tool base frame 201. However, the robotic arm assembly base 202 may be positioned near the top portion of the tool body frame 201 or may be duplicated near the top of the tool body frame 201. In an aspect, the robotic arm assembly base 202 may be stationary in relationship to the tool body frame 201. In an aspect, the robotic arm assembly base 202 may be movable in relationship to the tool body frame 201, such as moving linearly in horizontal directions, vertically or rotating about an axis defined by the center of the robotic arm assembly base 202. It is understood that the position of the robotic arm assembly base 202 may be located as needed, and not only as depicted in the aspect shown in FIG. 2. The universal milling machine assembly tool 100 is capable of accommodating different types of motion of the workpiece, including linear motion, reciprocating motion, circular/orbital motion, Brownian motion (depending on the scale of the workpiece and the universal milling machine assembly tool 100), curvilinear motion along multiple axes, oscillatory—(swinging from side to side), simultaneous motions (when two or more above listed motions acts simultaneously, vibratory motion, motion oscillation, wave form synthesis, wave manipulation, floating motion and/or combinations thereof. The motions acceptable to universal milling machine assembly tool 100 may be programmed ahead of machining or synthesized in real time as the workpiece is being processed. In an aspect, the universal milling machine assembly tool may be programmed to apply different types of finishes to a work piece, depending on a user's application. In an aspect, the finishes are oscillations, waveform synthesized or waveform or even “polka music” waveform or rock'n'roll type music or could have a float function to float freely. Different levels of capability and functionality may be included in the universal milling machine assembly tool depending on the cost function and desired applications required by a user. The universal milling machine assembly tool 100 could have all the capabilities, some of the capabilities or none of the capabilities depending on the user preference or complexity of the equipment that was bought.

In an aspect, the universal milling machine assembly tool 100 could have or not have and/or have multiples of the same functionality and functional assemblies. The functionality and combination of assemblies may be customizable by the end user. In an aspect, the universal milling machine assembly tool 100 could even be a one arm mobile unit or the most sophisticated model with all or no options as the end user would want.

In an aspect, the universal milling machine assembly tool 100 could be programmed in any possible way that the use would or would or would not like, including using heat sensors for detection of other dangers fire out of the ordinary, intrusion detection, smoke/carbon monoxide or gas leak warning, etc. With input/output data, the universal milling machine assembly tool 100 would be able to be upgraded or added on later if newer capabilities became available for use by or with the universal milling machine assembly tool 100.

The universal milling machine assembly tool 201 includes one or more robotic arm assembly base couplers 203, where each of the one or more robotic arm assembly base couplers 203 is positioned in communication with and arrayed about the robotic arm assembly base 202. There may be only one robotic arm assembly base coupler 203 if only the use of one robotic arm assembly is required. In an aspect, there may be multiple robotic arm assembly base couplers 203 if more than one robotic arm assembly is required.

The universal milling machine assembly tool 200 includes one or more robotic arm assemblies 204, in articulating communication with the one or more robotic arm assembly base couplers 203. The one or more robotic arm assemblies 204 may be pivotably attached to one or more base coupler joints. The one or more robotic arm assemblies 204 may include a proximal attachment end 204a for each of the one or more robotic arm assemblies 204. The one or more robotic arm assemblies 204 may include one or more robotic arm assembly connecting rods 205, where a first robotic arm assembly connecting rod 205a is in communication with the proximal attachment end 204a for each of the one or more robotic arm assemblies 204.

The one or more robotic arm assemblies 204 may include one or more articulating joints 206 positioned between each of the one or more robotic arm assembly connecting rods 205, where the one or more articulating joints 206 allow the one or more robotic arm assembly connecting rods 205 a defined range of motion in space about the one or more articulating joints 206. The defined range of motion in space may be some 3D range of motion about the one or more articulating joints 206 to allow a larger range of motion for the robotic arm assembly 204.

A distal attachment end 207 is provided for each of the one or more robotic arm assemblies 204, where the distal attachment end 207 is in communication with a distal robotic arm assembly connecting rod 208 of the one or more robotic arm assembly connecting rods 205.

In an aspect, the universal milling machine assembly tool 100 may work with other machines specified herein wirelessly or corded and may include data input/output drives, virus software, AI-supported or human-operated or programming or any combination thereof.

In an aspect, a robotic hand the universal milling machine assembly tool 100 could be represented by a chuck of sorts which would be capable of the types of motion described herein and then also could be the head unit capable of the types of motion described herein.

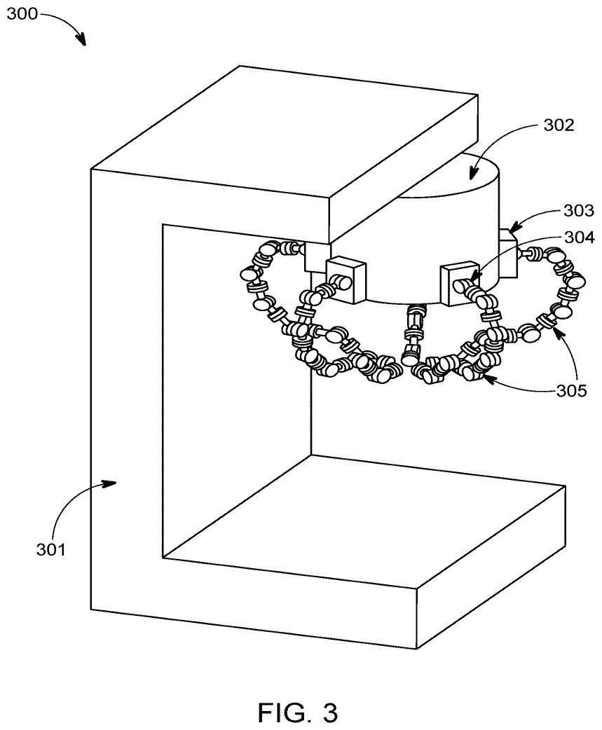

FIG. 3 is a view of a third aspect of a universal milling machine assembly tool 300, according to the disclosure. FIG. 3 illustrates a view of FIG. 1 with the robotic assembly tool 300 disposed with a tool body frame 301 and a robotic arm assembly base 302 positioned in communication with the tool body frame 301 at the top portion of the tool body frame 301.

In an aspect, the robotic arm assembly base 302 may be stationary in relationship to the tool body frame 301. In an aspect, the robotic arm assembly base 302 may be movable in relationship to the tool body frame 301, such as moving linearly in horizontal directions, vertically or rotating about an axis defined by the center of the robotic arm assembly base 302. The universal milling machine assembly tool 100 is capable of accommodating different types of motion of the workpiece, including linear motion, reciprocating motion, circular/orbital motion, Brownian motion (depending on the scale of the workpiece and the universal milling machine assembly tool 100), curvilinear motion along multiple axes, oscillatory—(swinging from side to side), simultaneous motions (when two or more above listed motions acts simultaneously, vibratory motion, motion oscillation, wave form synthesis, wave manipulation, floating motion and/or combinations thereof. The motions acceptable to universal milling machine assembly tool 100 may be programmed ahead of machining or synthesized in real time as the workpiece is being processed. In an aspect, the universal milling machine assembly tool may be programmed to apply different types of finishes to a work piece, depending on a user's application. In an aspect, the finishes are oscillations, waveform synthesized or waveform or even “polka music” waveform or rock'n'roll type music or could have a float function to float freely. Different levels of capability and functionality may be included in the universal milling machine assembly tool depending on the cost function and desired applications required by a user. The universal milling machine assembly tool 100 could have all the capabilities, some of the capabilities or none of the capabilities depending on the user preference or complexity of the equipment that was bought.

The universal milling machine assembly tool 301 includes one or more robotic arm assembly base couplers 303, where each of the one or more robotic arm assembly base couplers 303 is positioned in communication with and arrayed about the robotic arm assembly base 302. There may be only one robotic arm assembly base coupler 303 if only the use of one robotic arm assembly is required. In an aspect, there may be multiple robotic arm assembly base couplers 303 if more than one robotic arm assembly is required.

The universal milling machine assembly tool 200 includes one or more robotic arm assemblies 305, in articulating communication with the one or more robotic arm assembly base couplers 303. The one or more robotic arm assemblies 305 may be pivotably attached to one or more base coupler joints 304. The one or more robotic arm assemblies 305 are otherwise identical to the one or more robotic arm assemblies illustrated in FIG. 1 and FIG. 2, where like numeral references are reflected in the view of the aspect of the universal milling machine assembly tool 300 in FIG. 3.

FIG. 4 is a view of a robotic arm attachment tool 400, according to the disclosure. The robotic arm attachment tool 400 may be attached to the distal attachment end 107 illustrated in FIG. 1 or the distal attachment end 207 illustrated in FIG. 2. The robotic arm attachment tool 400 includes a robotic arm attachment coupler 401, where the robotic arm attachment coupler 401 is configured to attach to the distal attachment end (107, 207).

The robotic arm attachment tool 400 includes a robotic hand base 402 in pivotable communication with the robotic arm attachment coupler 401. One or more robotic actuating fingers 403 are in actuating communication with the robotic hand base 402. In an aspect, the one or more robotic actuating fingers 403 include one or more robotic finger tips positioned at a distal end location of one of the one or more robotic actuating fingers 404 and one or more robotic finger actuating joints 405 in actuating communication with one or more robotic finger connecting spurs 406. The one or more robotic finger connecting spurs 406 further include a proximal finger connecting spur 406a in actuating communication with the robotic hand base 402 and a distal finger connecting spur 406b in actuating communication with one of the one or more robotic finger actuating joints 405a and in actuating communication with one of the one or more robotic finger tips 404. In an aspect, the robotic arm attachment tool 400 may be configured for holding work pieces with or without oscillation of the work piece or the robotic arm attachment tool 400. The universal milling machine assembly tool 100 is capable of accommodating different types of motion of the workpiece, including linear motion, reciprocating motion, circular/orbital motion, Brownian motion (depending on the scale of the workpiece and the universal milling machine assembly tool 100), curvilinear motion along multiple axes, oscillatory—(swinging from side to side), simultaneous motions (when two or more above listed motions acts simultaneously, vibratory motion, motion oscillation, wave form synthesis, wave manipulation, floating motion and/or combinations thereof. The motions acceptable to universal milling machine assembly tool 100 may be programmed ahead of machining or synthesized in real time as the workpiece is being processed. In an aspect, the universal milling machine assembly tool may be programmed to apply different types of finishes to a work piece, depending on a user's application. In an aspect, the finishes are oscillations, waveform synthesized or waveform or even “polka music” waveform or rock'n'roll type music or could have a float function to float freely. Different levels of capability and functionality may be included in the universal milling machine assembly tool depending on the cost function and desired applications required by a user. The universal milling machine assembly tool 100 could have all the capabilities, some of the capabilities or none of the capabilities depending on the user preference or complexity of the equipment that was bought.

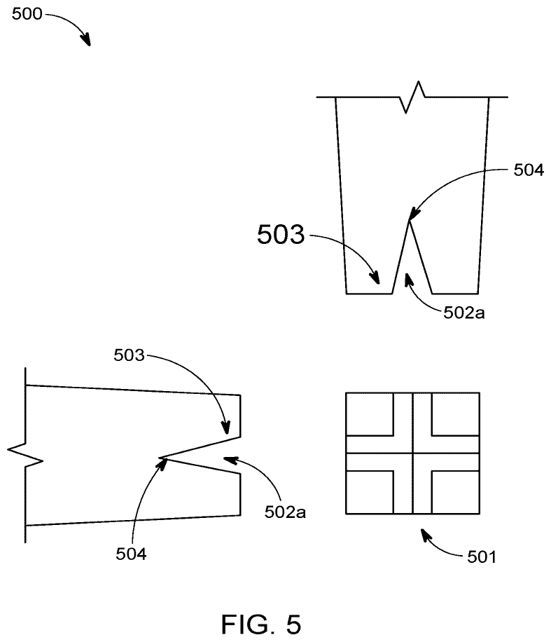

FIG. 5 is a view of an end tip 500 of a robotic arm attachment tool finger tip 404, according to the disclosure. Each of the one or more robotic finger tips 404 may include an indented gripping pattern 501 disposed upon a distal end of one of the one or more robotic finger tips 404. The indented gripping pattern 501 is configured to securely hold a work piece during processing. In an aspect, when the work piece has a curved or circular cross-section or surface, such as a dowl, cylinder or ball shape, the indented gripping pattern 501 works to secure the work piece for processing, with or without oscillation of the work piece or the robotic arm attachment tool 400. The universal milling machine assembly tool 100 is capable of accommodating different types of motion of the workpiece, including linear motion, reciprocating motion, circular/orbital motion, Brownian motion (depending on the scale of the workpiece and the universal milling machine assembly tool 100), curvilinear motion along multiple axes, oscillatory—(swinging from side to side), simultaneous motions (when two or more above listed motions acts simultaneously, vibratory motion, motion oscillation, wave form synthesis, wave manipulation, floating motion and/or combinations thereof. The motions acceptable to universal milling machine assembly tool 100 may be programmed ahead of machining or synthesized in real time as the workpiece is being processed. In an aspect, the universal milling machine assembly tool may be programmed to apply different types of finishes to a work piece, depending on a user's application. In an aspect, the finishes are oscillations, waveform synthesized or waveform or even “polka music” waveform or rock'n'roll type music or could have a float function to float freely. Different levels of capability and functionality may be included in the universal milling machine assembly tool depending on the cost function and desired applications required by a user. The universal milling machine assembly tool 100 could have all the capabilities, some of the capabilities or none of the capabilities depending on the user preference or complexity of the equipment that was bought.

In an aspect, the indented gripping pattern 501 may be formed in an intersecting cross-shaped pattern indented into the distal end of the one of the one or more robotic finger tips 404 and include an indentation 502a, 502b on each side face of the one or more robotic finger tips 404. The indentation 502a, 502b may extend with a maximum lateral width 503 from the distal end of the one or more robotic finger tips 404 to a minimum lateral width 504 at a point along each side face of the one or more robotic finger tips 404. In an aspect, the indentation 502a, 502b comprises a V-shaped indentation.

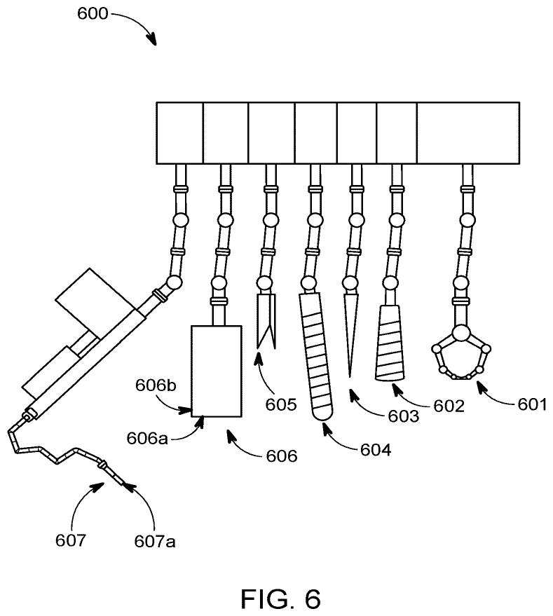

FIG. 6 is a view of aspects of universal robot assembly arms 600, according to the disclosure. The one or more robotic arm assembly attachment tools may include a robotic arm attachment tool 601, a machining tool 602, a material printing tool 603, an absolute zero tolerance robotic holding arm tool 604, a welding attachment tool 605, a flat surface tool 606 or a fastener assembly tool 607. Other attachment tools are possible as required for particular processing of work pieces. The universal milling machine assembly tool 100 is capable of accommodating different types of motion of the workpiece, including linear motion, reciprocating motion, circular/orbital motion, Brownian motion (depending on the scale of the workpiece and the universal milling machine assembly tool 100), curvilinear motion along multiple axes, oscillatory—(swinging from side to side), simultaneous motions (when two or more above listed motions acts simultaneously, vibratory motion, motion oscillation, wave form synthesis, wave manipulation, floating motion and/or combinations thereof. The motions acceptable to universal milling machine assembly tool 100 may be programmed ahead of machining or synthesized in real time as the workpiece is being processed. In an aspect, the universal milling machine assembly tool may be programmed to apply different types of finishes to a work piece, depending on a user's application. In an aspect, the finishes are oscillations, waveform synthesized or waveform or even “polka music” waveform or rock'n'roll type music or could have a float function to float freely. Different levels of capability and functionality may be included in the universal milling machine assembly tool depending on the cost function and desired applications required by a user. The universal milling machine assembly tool 100 could have all the capabilities, some of the capabilities or none of the capabilities depending on the user preference or complexity of the equipment that was bought.

The robotic arm attachment tool 601 is described in detail in relation to FIG. 4 and FIG. 5 above. The machining tool 602 is configured to machine process a work piece. The machining tool 602 is configured to adapt to oscillation of the work piece during the machine process, with or without oscillation. In an aspect, the machining tool 602 could have a station like the printing station for cooling and lubricant when cutting parts. In an aspect, the machining tool 602 may include a saw for cutting materials. In an aspect, the machining tool 602 may be an acoustic/ultrasonic tool for acoustic machining and processing applications.

The material printing tool 603 is configured to apply additive printing material to a work piece and the material printing tool 603 is configured to adapt to oscillation of the work piece during an additive printing process, with or without oscillation. The material printing tool 603 may be adapted to paint work pieces as well.

In an aspect, the additive printing process employed by the material printing tool 603 may include a 3D printing material application, a stereolithography printing material application, an ink-based material application, a metal-based material application or an organic-based material application.

In an aspect, the material printing tool 603 may include a water jet for cutting.

In an aspect, the absolute zero tolerance robotic holding arm tool 604 is configured for holding power with or without oscillation for making work pieces with absolute zero tolerance spacing or flatness. The absolute zero tolerance robotic holding arm tool 604 functions like a vice on a CNC machine that can move in any x y z type of motion. The absolute zero tolerance robotic holding arm tool 604 could twist and be oriented in any direction. Flatness is defined as a size of mechanical geometric plane deviation which means that the flatness is defined as virtual upper plane and a virtual lower plane. Two parallel planes cover the smallest distance between the two planes, which is called flatness.

In an aspect, the welding attachment tool 605 comprises a welding assembly configured to weld two or more work pieces together. In an aspect, the welding attachment tool 605 may include a laser or plasma cutter for cutting metal.

In an aspect, the welding attachment tool 605 may include or be complemented by an electrical discharge machining (EDM) tool. As known to one of skill in the art, Electrical discharge machining (EDM), also known as spark machining, spark eroding, die sinking, wire burning or wire erosion, is a metal fabrication process whereby a desired shape is obtained by using electrical discharges (sparks). Material is removed from the work piece by a series of rapidly recurring current discharges between two electrodes, separated by a dielectric liquid and subject to an electric voltage. One of the electrodes is called the tool-electrode, or simply the tool or electrode, while the other is called the workpiece-electrode, or work piece. The process depends upon the tool and work piece not making physical contact. In an aspect, the EDM tool may be a sinker EDM, ram EDM, cavity-type EDM or volume EDM tool, which consists of an electrode and workpiece submerged in an insulating liquid.

In an aspect, the EDM tool may include a CNC wire-cut EDM tool. In an aspect, a wire electrical discharge machining (WEDM) may be included, also known as wire-cut EDM and wire cutting, where a thin single-strand metal wire, usually brass, is fed through the workpiece, submerged in a tank of dielectric fluid, typically deionized water.

In an aspect, the flat surface tool 606 comprises a flat surface 606a at a distal end 606b of the flat surface tool 606. In an aspect, the flat surface tool 606 is configured to build a work piece with material added in a sequential process.

In an aspect, the fastener assembly tool 607 comprises a fastening device 607a configured to apply a fastener to a work piece. In an aspect, the fastener may be a screw, a nail, a rivet, glue, epoxy, solder, etc.

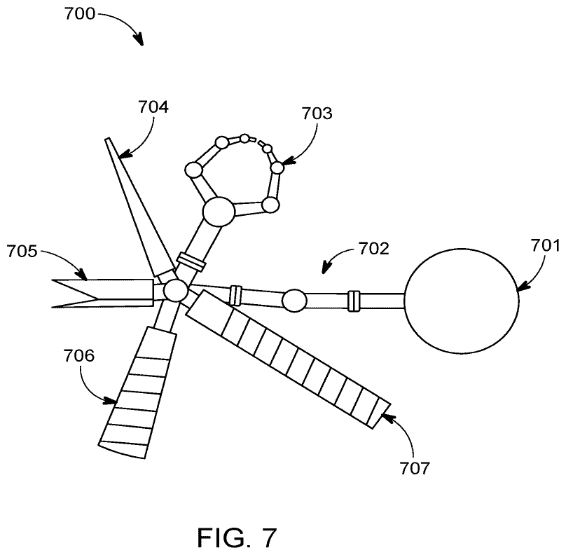

FIG. 7 is a view of an aspect of a universal milling machine assembly tool 700, according to the disclosure. In FIG. 7, a robotic assembly base 702 supports a robotic assembly arm 702, such as that illustrated in FIGS. 1-3. Along the robotic assembly arm 702 may be one or more robotic arm assembly attachment tools, such as a robotic arm attachment tool 703, a material printing tool 704, a welding attachment tool 705, a machining tool 706 and a flat surface tool 606, for example. In an aspect, the machining tool 706 may be an autobody fixing tool to perform repairs or form lines of an automobile being worked upon. The machining tool 706 may include an autobody kit configured to stretch car frames and do wheel alignments, among other autobody applications. Other configurations and arrangements of robotic arm assembly attachment tools may be possible depending on the application on the work piece. The machining tool 706 may be configured for automotive applications to include molds for mechanical stamping, body panels and parts of cars for automotive design and repair.

The universal milling machine assembly tool can be configured to be an interface with different types of control applications and software. In an aspect, the universal milling machine assembly tool may be configured to interface with an enterprise resource planning (ERP) software system (such as a SAP or like ERP system) to coordinate accounting functions with engineering and manufacturing operations in one system. The universal milling machine assembly tool may have customer resource management (CRM) software capabilities to allow sales and support functions integrated with engineering and manufacturing operations in one system, such as, for example, generating advertising, sales quotes, responding to customer inquiries, processing orders and invoices and integrating sales, financial and manufacturing systems all in one system.

In aspect, the universal milling machine assembly tool may be configured to operate corporate functions integrated with the manufacturing applications of the tool. The universal milling machine assembly tool may be configured, within regulatory constraints, to set up a publicly traded company for the operator and link to stock and trade exchanges for financial services and trading applications.

In an aspect, universal milling machine assembly tool can be configured to operate as a CAD system, prototyping system or layout planner. The universal milling machine assembly tool can be configured to host or accept design files of different formats to allow manufacture and machining of parts based on input design files from an engineer or customer desiring a part.

In an aspect, the universal milling machine assembly tool may be enclosed or open depending on the application or location of the tool. The universal milling machine assembly tool may include a venting, vacuum and/or waste disposal tool to efficiently remove detritus and scrap from the tool.

In an aspect, the universal milling machine assembly tool may be used in different environments, such as home crafting, hobbyist, do-it-yourself applications, metal crafting, wood crafting, plastic crafting, stone crafting, automotive or other smaller scale applications outside of an industrial application. Other applications include manufacturing of any type of good at home such as toys, accessories, electronics, coordinating home networks for entertainment and home automation and meal preparation. Other applications include pharmaceutical preparations and chemistry/process control automation and regulation.

In an aspect, the universal milling machine assembly tool may be programmed to apply different types of finishes to a work piece, depending on a user's application. In an aspect, the finishes are oscillations, waveform synthesized or waveform or even “polka music” waveform or rock'n'roll type music or could have a float function to float freely. Different levels of capability and functionality may be included in the universal milling machine assembly tool depending on the cost function and desired applications required by a user.

In an aspect, the universal milling machine assembly tool may include a mixing station, such as a melting pot, which would/could (depending on the variation of the machine) have a separate chamber for making items under pressure or in a vacuum then the chamber could be set to the right pressure before dropping in the materials into the mixing station to feed the universal milling machine assembly tool. In an aspect, the mixing station may be configured for plastic extrusion processes through screw and die, polymer extrusion and other plastic forming technologies. The mixing station could be adapted to provide metal extrusion or any other type of substances one of skill in the art would want to extrude.

In an aspect, universal milling machine assembly tool may include a powder coating component, with a hot/cold pot for riveting or making things cold and heating for fitting metal sleeves or such process.

In an aspect, the finger tips the universal milling machine assembly tool could be made out of soft material for handling delicate materials or objects and could even have sensing systems in the fingers, such as for cracking an egg for baking a cake in its warming pot or hot pot. Other meal preparation applications are possible as well.

In aspect, the universal milling machine assembly tool may include packaging components for shrink-wrapping, boxing or affixing labels to packaging as a finished product. In an aspect, the tool may have changeable cartridges so that it could fast apply and change out to more whatever it is needed.

The universal milling machine assembly tool is designed to accommodate casting/molding, machining, joining and shearing/forming. The universal milling machine assembly tool is designed to accommodate the five types of manufacturing processes: repetitive manufacturing; discrete manufacturing; job shop manufacturing; process manufacturing (continuous); and process manufacturing (batch).

The universal milling machine assembly tool 700 is designed to be of different scales and portability depending on the application. The universal milling machine assembly tool may be scaled up to build anything on an aircraft carrier a cruise ship, colosseums, skyscrapers and scaled down to microscopic and nanoscopic levels for nanotechnology applications, surgical applications and submicron manufacturing or machining. The universal milling machine assembly tool may be positioned in one place or be configured to be portable for different locations within a facility or transport to other locations as needed. In an aspect, the universal milling machine assembly tool 700 may be self-powered by power sources coupled with the universal milling machine assembly tool 700, such as by a battery, fuel cell, solar power cell or other portable power supply devices known to one of skill in the art.

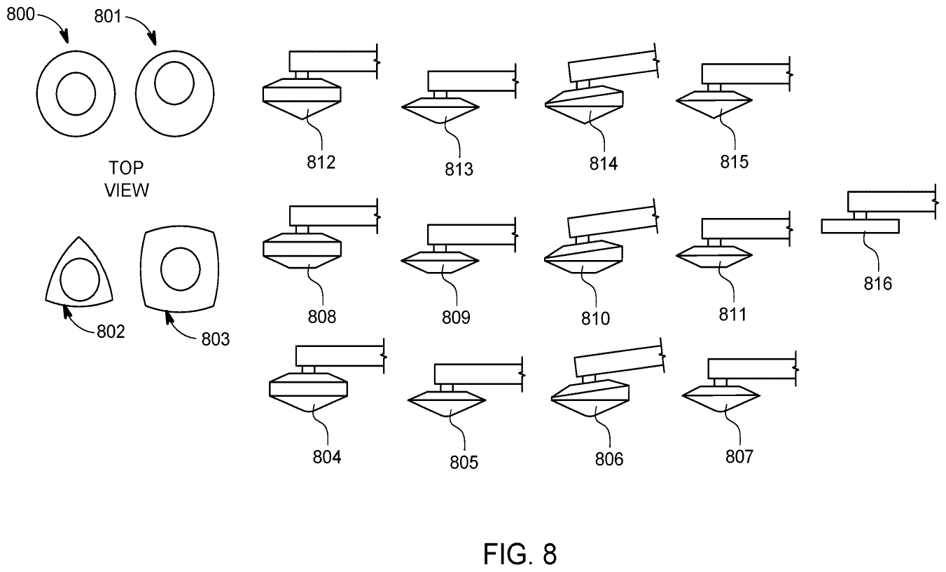

FIG. 8 is a view of a grinding/sanding tool attachment 800-816 for the universal milling machine assembly tool, according to the disclosure. In an aspect, four example top view of a grinding tool attachment 800-803 are illustrated. Other shapes may be contemplated by one of skill in the art. Side views of exemplary grinding tool attachments 804-816 are illustrated in FIG. 8, according to the disclosure. In an aspect of the disclosure, the grinding tool attachments 800-816 can oscillate with different frequencies, motions and waveforms as disclosed herein. The grinding tool attachments 800-816 may be adapted with a shim pack or thin layer of plastic material or ceramic material or even microscopic thin film coating to separate the grinding tool attachment from a surface and avoid scratching the surface. The grinding tool attachments 800-816 may be of different materials, thickness with flat, pointed, tapered or rounded contours as illustrated in FIG. 8. The bottom surfaces of the grinding tool attachments 800-816 may have a grit coating or no grit coating or even a nano layer/particle layer. Exemplary grinding tool shapes and applications are also described in U.S. Patent Publication US 20230249309A1, “Adaptable Sanding Apparatus and Method,” the contents of which are incorporated by reference in their entirety. In an aspect, a sanding tool may include a sander body having a motor and an oscillating arm; a plurality of interchangeable frames for holding sandpaper, the frames being arranged and configured to be selectively coupled to the motor for creating a sanding motion in order to alternatively and selectably sand surfaces in two planes; at least one detail sanding pad positioned on one of said frames, said frames each having a substantially flat lower surface which may be selectively covered with abrasive material and said sanding pad having a substantially pointed front portion bounded laterally by two vertically oriented surfaces having an included angle of less than 90 degrees, at least one of said two surfaces covered with an abrasive material; whereby abrasive material may be positioned selectively on one or more of said two surfaces or said lower surface of said frame. In a further aspect, a sanding system may be employed which can be useful for sanding adjacent perpendicular or nearly perpendicular surfaces simultaneously, which can be configured for variations in the angle between the surfaces. A sanding system allows for providing sanding pads configured to treat two or more adjacent surfaces where the surfaces to be treated lie in different planes or are substantially perpendicular. Each sanding pad has two or more abrasive surfaces lying in different planes. The relative angles of the abrasive surfaces is variable, and the abrasive material may be selectively removed so that at least one surface of the pad is smooth and can be used as a guide placed against one of the adjacent surfaces, this allowing the sander to operate as an edging tool.

In an aspect of the disclosure, a grinding wheel attachment tool may also be attached to a universal milling machine assembly tool. Grinding wheels are a very important part of finishing. A grinding wheel attachment tool may be configured in shape and size needed for the application. Various materials for the grinding wheel may be used, even extending to soft, pliable leather or cotton material for final finishing, for example. Different abrasive materials and substrates may be used. Cotton leather, microfibers, cloth, plastics, rubber to hard diamond materials may be used along with or any type of harder grit or softness.

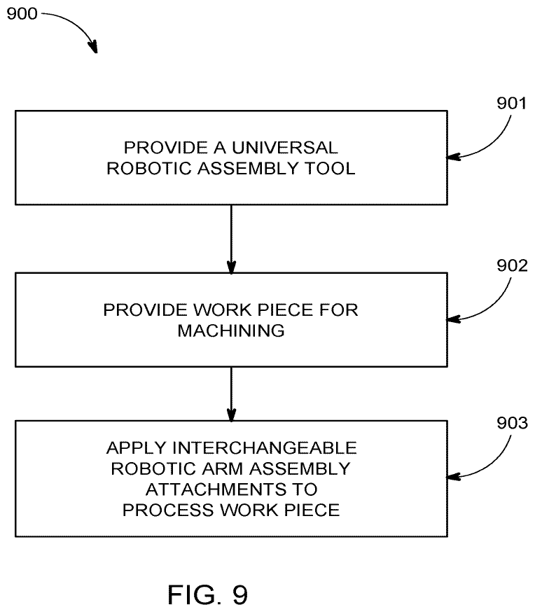

FIG. 9 illustrates an example flow chart 900 of acts taken to machine a work piece using a universal milling machine assembly tool, according to the disclosure.

At act 901, a universal robotic assembly machining tool is provided, such as the universal milling machine assembly tool 100, 200, 300. The universal milling machine assembly tool may include one or more one or more articulating robotic arm assemblies, where the one or more one or more articulating robotic arm assemblies comprise one or more robotic arm assembly connecting rods connected to each other through one or more articulating joints along the one or more robotic arm assemblies; an attachment end for each of the one or more robotic arm assemblies, and one or more interchangeable robotic arm assembly attachment tools attachable to the attachment end for each of the one or more robotic arm assemblies. The robotic arms depicted in 100, 200 and 300 are representative aspects. Each arm may have more or less joints with a quick connect feature to extend or replace the rotation joint. A robotic arm would be ideal for adding or replacing, shortening or lengthening sections which also would have pins for alignment so that it could be quickly changed with each arm that would have data telling back to home how long each arm is and what its capabilities are.

At act 902, a work piece is provided to be machined by the universal robotic assembly machining tool.

At act 903, one or more interchangeable robotic arm assembly attachment tools are applied to process the work piece. The work piece may be machined to a desired shape or precision, have printed material applied to it, have other work pieces added to it, welded to other work pieces or other machining and work piece processing contemplated by the intended use of the finished work piece. Machining may include, but not limited to, grinding, cutting, polishing, deburring, drilling, cutting, sanding, carving, embossing, engraving. In an aspect, the machining by the universal milling machine assembly tool may directed by a CNC application or module or other programmable interface to direct the tool. In an aspect, the universal milling machine assembly tool may be directed by software control systems such as artificial intelligence, machine learning or evolutionary algorithm smart software controls. In an aspect, the artificial intelligence software may be based on neural networks, supervised and unsupervised learning, reactive, limited memory, theory of mind, self-aware and general purpose artificial intelligence models. In an aspect, the software interfaces may be configured to interact with human operators in a natural language environment, adapting to the spoken language, personalities and work styles of the human operators. The universal milling machine assembly tool may interact with humans by reading eye movement, body language, heart beat, respiration, etc. An advantage of the disclosed universal milling machine assembly tool is that it can be configured with interchangeable robotic arm assembly attachment tools as needed for the desired machining work. Work pieces may be processed with or without oscillation, synthesis or any type of waveform of the work piece, the holders or spindles of the universal milling machine assembly tool. Other advantages may be realized by application of the present disclosure without deviating from the scope of the disclosure.

In an aspect of the disclosure, when machining for the oscillating or synthesis mode, the universal milling machine assembly tool would have a float mode, generating free movement between the two states of oscillating mode and synthesis modes. The edges of the profiles of the tools could be curved and could have multiple radiuses like a French curve or spline. The layer on the bottom of the universal milling machine assembly tool could be nanotechnology-engineered. In an aspect, there could be an insert on the bottom of the universal milling machine assembly tool for a “professional model” with height/side/angle adjustment. In an aspect, the universal milling machine assembly tool may have a bearing in it for the “professional model.” In an aspect, the universal milling machine assembly tool may include a bushing for a lower grade model. In an aspect, the universal milling machine assembly tool may include a base that is contoured to the shape of the tool. In an aspect, the universal milling machine assembly tool may include a base that the universal milling machine assembly tool slips over. In an aspect, the universal milling machine assembly tool may include a tool to reshape the contour of the work piece to whatever profile desired. The base would be adjustable so that the user could resharpen or reshape the tool to make a new tool or redefine the existing tool. A nano-edge could be used to pry to help force the shape into the existing surface. The reshape/resurface tool could be different tool packages. The universal milling machine assembly tool could have multiple scenarios of this or some or all of the listed implementations. In an aspect, the universal milling machine assembly tool could be hooked up to a right angle drill or an oscillator. The universal milling machine assembly tool may be configured to run under its own power.

The universal milling machine assembly tool may be incorporated onto or adapted to work with humanoid robotic workers in manufacturing, assembly or settings. The humanoid robotic worker using a universal milling machine assembly tool may be involved in creating items from a microscopic or nanoscopic scale all the way to bridges, tunnels, stadiums and buildings, or even scaled to build a city, for example. In an aspect, the universal milling machine assembly tool could be incorporated with a simple robot with or without wheels up to the most advanced robotic system. The universal milling machine assembly tool could be micro-sized in the finger of the robot to the biggest robot that could build a city, building piping or tubing or tunnels. The universal milling machine assembly tools would be able to interact with each other or communicate to each other to work through schedule tables.

The example humanoid robotic workers could operate heavy equipment, tractor trailer trucks, back hoes, crane and other heavy machinery. The example humanoid robotic workers could also use hand tools such as a drill oscillator tool, sanding pad, shovel, pick, and the like. The example humanoid robotic workers employing a universal milling machine assembly tool could be used in hazardous environments, environments with tedious or repetitive processes that may not be suitable or desirable for human workers to inhabit. The finger tips on the ends of the universal milling machine assembly tool hands could be made from a silicone type material to mimic human softness and touch. In an aspect, a humanoid robot could open and reveal a small version of the universal milling machine assembly tool for small scale operations. In an aspect, a cybernetic implant of a universal milling machine assembly tool may be contemplated for integration with a human finger, if someone had an accident and was missing the tip of their finger, for instance. In another aspect of the disclosure, the humanoid robotic worker and/or an attached universal milling machine assembly tool could oscillate with a desired waveform or synthesis of waveforms or any type of waveforms. The universal milling machine assembly tool 100 is capable of accommodating different types of motion of the workpiece, including linear motion, reciprocating motion, circular/orbital motion, Brownian motion (depending on the scale of the workpiece and the universal milling machine assembly tool 100), curvilinear motion along multiple axes, oscillatory—(swinging from side to side), simultaneous motions (when two or more above listed motions acts simultaneously, vibratory motion, motion oscillation, wave form synthesis, wave manipulation, floating motion and/or combinations thereof. The motions acceptable to universal milling machine assembly tool 100 may be programmed ahead of machining or synthesized in real time as the workpiece is being processed.

In an aspect, the universal milling machine assembly tool may have the basic characteristics of a milling machine and then be enhanced with a waveform or type of oscillatory synthesis. Examples of milling techniques include, but are not limited to, horizontal milling machines; CNC milling; vertical milling machines; column and knee type milling machines; gang milling; thread milling; drum milling machines; fixed bed milling machines; end milling; face milling; angle milling; form milling; gear cutting; universal milling machines; planer milling machines; tracer controlled milling machines; bed mill; slot milling; turret; slab milling and other milling technologies known to one of skill in the art. Types of oscillations that may be contemplated for use with the universal milling machine assembly tool include: a) free oscillation—when an oscillator oscillates with its frequency; b) damped oscillations—the oscillation that decreases with time; c) forced oscillations—any oscillations that are forced to happen with external factors. Other ways to manipulate the waveform known to one of skill in the art is digital or analog synthesis, where the waveform is synthesized in a way to either oscillate or make a custom oscillatory pattern with any kind of waveform adjustments in frequency, amplitude, pitch, tone, rhythm, pace with desired musical styles. The waveform synthesis for the universal milling machine assembly tool may be fully programmable and reversible by the user, allowing backstepping to extenuate the finish/flatness or multi cross path of different functions.

The universal milling machine assembly tool may be fully programmable such that a new standard of accuracy could be attained. Responsive joints within the universal milling machine assembly tool could have preprogrammed responses built into them for zeroing, such that each machine could have a “re-zero” target spot so that it could understand and “re-zero” (calibrate) itself. In an aspect, the universal milling machine assembly tool may include a pressure switch built in so that it could touch off and zero in on the absolute zero point. The universal milling machine assembly tool may have photosensors and LiDAR sensors that could be used to provide feedback and data to operators of the universal milling machine assembly tool or an augmented or artificial intelligence agent controlling the universal milling machine assembly tool.

In an aspect, one of the tools of the universal milling machine assembly tool may be a feeler gauge. A ball end of a feeler gauge may be used to calibrate the zero point of the universal milling machine assembly tool. The feeler gauge could be microscopic so that it could hold the tightest tolerances. The dial on the feeler gauge could read to the machine or to the human or both to record actual versus what is built, so then the machine could even know what targets that it hits or what it does not. In an aspect, this feedback may have a positive/negative analysis around the targeted zero point.

In an aspect, the universal milling machine assembly tool may include money management software and/or hardware that may allow the universal milling machine assembly tool to execute financial transactions, such as stock, bond, commodity, bitcoin, non-fungible token trading. The money management functionality may allow searching on websites for desired goods or participate in online auctions. In this aspect, the universal milling machine assembly tool could appraise or fix or repair cars or equipment, such as by effecting corrections, re-wiring or upgrading components in a desired item.

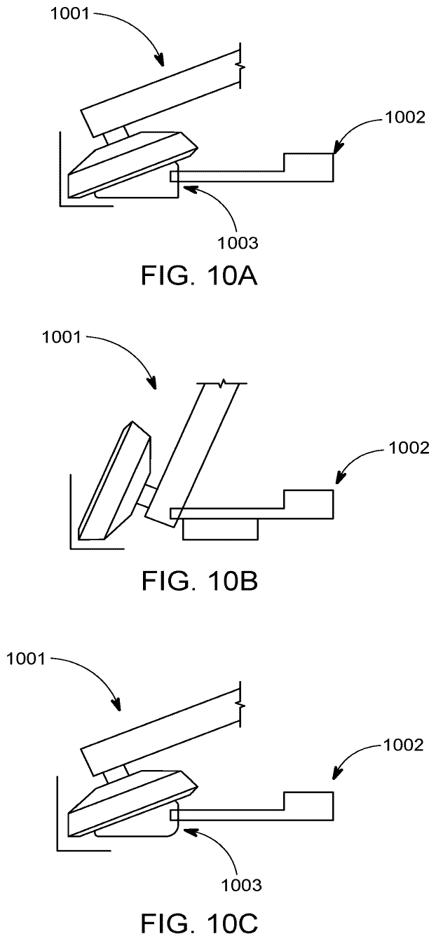

FIG. 10A is a view of a universal milling machine assembly tool 1001 with a knee kicker 1002, allowing a user to create extra pressure in a direction either perpendicular to a surface or at an angle to the surface. A swivel joint/base 1003 facilitates movement of the knee kicker 1002 about the universal milling machine assembly tool 1001. The knee kicker 1002 may also be used to get debris out of the way of operations.

FIG. 10B shows an upside down view of FIG. 10A, and shows using the bottom of the universal milling machine assembly tool 1001.

FIG. 10C shows another view of the universal milling machine assembly tool 1001. In an aspect, the swivel joint/base 1003 may be rounded for leverage of pressure downward. The aspect shown in FIG. 10C may be used to remove debris out of the way or for extra desired pressure to reinforce the tool universal milling machine assembly tool 1001.

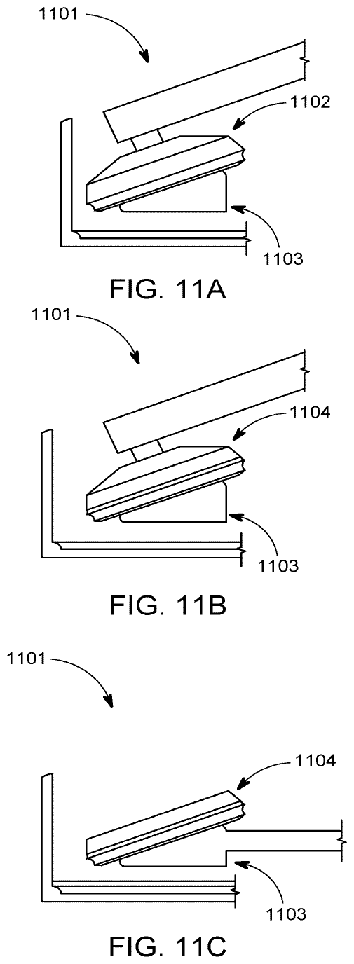

FIG. 11A shows a view of a swivel joint base 1103 in communication with a universal milling machine assembly tool 1101 with an interchangeable head 1102. In an aspect, a user could have fine tuning if the edge comes out of shape. In an aspect, the universal assembly tool 1101 may have a reshaping tool. In an aspect, a user may use the tool from FIG. 10A and then resharpen or reshape the tool and get the configuration of FIG. 11A.

FIG. 11B shows an oscillator 1104 which could be attached onto the base of the universal milling machine assembly tool 1101 to secure a desired look, much like honing a knife edge and which could be fully adjustable. In an aspect, the edges of the profiles of the tools could be curved and could have multiple radiuses, such as a French curve. The layer on the bottom could be nanotechnology. In an aspect, there could be an insert on the bottom for the professional model with height/side/angle adjustment. In an aspect, the universal milling machine assembly tool may include a bearing in it for the professional model or a bushing for a lower level version. The base could contour to the shape of the tool or it could be a base that the tool slips over. In an aspect, the universal milling machine assembly tool may include a tool to reshape the contour to whatever profile desired. The base would be adjustable, so that a user could resharpen or reshape the tool to make a new or redefine the existing. The nano edge could be used to pry to help force the shape into the existing surface. The reshape/resurface tool could be different tool packages. The tool could have multiple scenarios of this or some or all of the listed. In an aspect, the universal milling machine assembly tool could be hooked up to a right angle drill or an oscillator.

FIG. 11C shows the oscillator 1104 tool upside down. . . . Being powered from the bottom

In an aspect the universal milling machine assembly tool may include different types of inserts on the tool. Some may be used by professionals. In an aspect, different leverage points or rollers or bearings may be substituted. When machining for the oscillating or synth mode, the universal milling machine assembly tool may have a float mode, with random motions and free movement.

In an aspect, the edges of the profiles of the tools could be curved and could have multiple radiuses, such as a French curve. The layer on the bottom could be nanotechnology. In an aspect, there could be an insert on the bottom for the professional model with height/side/angle adjustment and could be self-powered. In an aspect, the universal milling machine assembly tool may include a bearing in it for the professional model or a bushing for a lower level version. The base could contour to the shape of the tool or it could be a base that the tool slips over. In an aspect, the universal milling machine assembly tool may include a tool to reshape the contour to whatever profile desired. The base would be adjustable, so that a user could resharpen or reshape the tool to make a new or redefine the existing. The nano edge could be used to pry to help force the shape into the existing surface. The reshape/resurface tool could be different tool packages. The tool could have multiple scenarios of this or some or all of the listed. In an aspect, the universal milling machine assembly tool could be hooked up to a right angle drill or an oscillator.

In an aspect, the desired edge would be built into the tool and surfacing or coating technology. The universal milling machine assembly tool could be used with any of the tooling with or without. The surfaces of the grinding tool could be smooth in some parts to help use guidance. In an aspect, the universal milling machine assembly tool is fully programmable.

In an aspect, the universal milling machine assembly tool may be used for buying raw products and creating things from scratch for money, such as circuitry, automotive parts, industrial parts or anything in taking raw products to making them a finished good to generate a positive cash flow. In an aspect, the universal milling machine assembly tool could rebuild houses, boats, toys, etc. The universal milling machine assembly tool may be able to access current engineering specifications, building codes and future building codes and connected to the information highway.

In an aspect, the universal milling machine assembly tool may assist in surgical operations, such as heart surgery or building an artificial heart and lungs while assisting with implantation. In an aspect, the universal milling machine assembly tool has technology of medical and sterilization capabilities. In an aspect, the universal milling machine assembly tool may specialize in nano technology or chemical bondage to be able to specialize in coatings or the thinnest material off the edge to an almost zero tolerance or just bonding on the other side of the tool with a different coating to have a different effect on a different surface. In an aspect, the universal milling machine assembly tool could be configured to construct any type of structures, up to the size of an aircraft carrier or supertanker. In an aspect, the universal milling machine assembly tool would perform calculations for responsiveness, points of leverage, or ability to tell friction coefficients of coatings or hardness, or the combination of both with the responsiveness from the sensory inputs to the universal milling machine assembly tool. The universal milling machine assembly tool may include the ability to be reset or recalibrated.

In an aspect, the universal milling machine assembly tool may include sensory control including temperature, pressure, vibration, rotary motion, etc. Further examples may include a tachometer for any kind of sensory perception, infrared sensors for temperature, eddy current sensors are used to measure position and expansion on shafts, bearing housings, and machine cases on rotating machines. Because of the large range in shaft and case sizes and the large possible range of movement, a range of different eddy current sensor sizes must be available to optimize the measurement of weight and measure certified with the ability to recalibrate. In an aspect, the universal milling machine assembly tool may include the capability to perform composition analysis on a molecular level with molecular weights and measures.

In an aspect, the universal milling machine assembly tool may include sensors for blood pressure, ultrasound, blood chemical composition, etc. In an aspect, the universal milling machine assembly tool may assist in dialysis or medical equipment. In an aspect, the universal milling machine assembly tool may perform sterilization of medical tools.

In an aspect, the universal milling machine assembly tool may include a sewing machine and thread dispenser. It may include the ability to take collected cotton hemp or the ability to clean or make synthetic thread and then have a loom that could dispense material. It may include the ability to make any machinery as a loom, so that a user may have some type of cloth weave. In an aspect, the universal milling machine assembly tool may make rugs, clothing, upholstery, carbon fiber, etc. With the universal milling machine assembly tool, spinning thread natural or made synthetically with the extrusion and spooling or collection, such as a Floyd loom for example.

In an aspect, the universal milling machine assembly tool may assist with craftsmen, construction workers or bakers/cake decorators, for example when plaster or other construction material is needed, or the universal milling machine assembly tool functions as a flat tool such as a trowel. In an aspect, for example, a construction worker could pump concrete or epoxy of sorts even though a universal milling machine assembly tool. Or a cake decorator pumping frosting using the flatness tool for decorating, or pumping/extruding frosting, or printing the design much as a 3D printer might.

In an aspect, the universal milling machine assembly tool may include X-ray, thermal imaging, ultraviolet imaging. In an aspect, the universal milling machine assembly tool could be powered by battery or fuel source (conventional gasoline or other power sources) or even build a windmill, hydroelectric or solar panels. In an aspect, the universal milling machine assembly tool also get electricity from the air known as an atmospheric energy station or any type of clean energy source such as fusion or self-contained energy sources or powered by interior/exterior types of power sources, with the ability to store power for the ability to shut down and start up at a later time or ability to be on an idle mode to conserve energy. In an aspect, the universal milling machine assembly tool may facilitate pressure or energy transfer from a source. The universal milling machine assembly tool may include cutting tools or removing a material process. The universal milling machine assembly tool may include a cold plasma or hot plasma torch laser torch or fluid or gas cutting or material removal. The universal milling machine assembly tool may be available in any type of robot. This robot is completely programmable ability with the ability to reset and include multiple combinations of AI. In an aspect, the universal milling machine assembly tool may include a large amount of combinations of different types of communication skills. The tool may be configured to monitor blood pressure, body language, eye movement, function as a lie detector if needed to, or may be a police officer or public service person. The universal milling machine assembly tool could be set up to communicate with a user psychologically with psychological interaction from sensory and perception by programming the AI with emotions and integrating so that it would like to learn about the user. The AI will help tailor whatever you would like to do that is capable of the system. In an aspect, the universal milling machine assembly tool could even read your mind from the electronic brain waves that you produce using brain functioning waves a.k.a. mind reading. There are several ways to test brain function, including Functional Magnetic Resonance Imaging (fMRI). This technology characterizes brain function at the level of neural processes by measuring blood flow in the brain. Electroencephalography (EEG): This technology records electrical activity in the brain. Electrocorticography (ECoG) records electrical activity directly from the surface of the brain. The Montreal Cognitive Assessment (MoCA) involves memorizing a short list of words, naming objects shown in pictures, copying shapes and performing other tasks. Mini-Mental State Exam (MMSE) involves counting backward, identifying objects in the room, stating the date and other common, well-known facts.

In an aspect, the universal milling machine assembly tool can assist a user with programming it and it could be continued to be programmed or be shut off or reset to an earlier period. It could be controlled not to or limited to certain entities.

In an aspect, the universal milling machine assembly tool including AI or robotics would specialize in advertising to generate an income from positive cash flow opportunities and access financial markets.

In an aspect, the universal milling machine assembly tool could communicate with speakers projection screen or on a screen or could have any type of inputs or outputs. The universal milling machine assembly tool could specialize in entertainment, comedy, magic, etc. It could include interactive stimulation. In an aspect, the universal milling machine assembly tool could have a creation mark or creation signature from objects made depending on regulation. It could have better or poor precision. In an aspect, the universal milling machine assembly tool may include power storage, including novel materials such as supercapacitors.

While various aspects of the disclosure have been described, it will be apparent to those of ordinary skill in the art that many more aspects and implementations are possible within the scope of the disclosure. Accordingly, the disclosure is not to be restricted except in light of the attached claims and their equivalents.

What is claimed is:

1. A universal milling machine assembly tool, the universal milling machine assembly tool comprising:
a tool body frame;
a robotic arm assembly base positioned in communication with the tool body frame;
one or more quick-connect robotic arm assembly base couplers, each of the one or more robotic arm assembly base couplers positioned in communication with and arrayed about the robotic arm assembly base;
one or more robotic arm assemblies, in articulating communication with the one or more robotic arm assembly base couplers with one or more pivotably attached base coupler joints, where the one or more robotic arm assemblies comprise:
a proximal attachment end for each of the one or more robotic arm assemblies;
one or more robotic arm assembly connecting rods, where a first robotic arm assembly connecting rod is in communication with the proximal attachment end for each of the one or more robotic arm assemblies;
one or more articulating joints positioned between each of the one or more robotic arm assembly connecting rods, where the one or more articulating joints allow the one or more robotic arm assembly connecting rods a defined range of motion in space about the one or more articulating joints,
a distal attachment end for each of the one or more robotic arm assemblies, where the distal attachment end is in communication with a distal robotic arm assembly connecting rod of the one or more robotic arm assembly connecting rods; and
one or more robotic arm assembly milling tools, where the one or more robotic arm assembly milling tools are interchangeably attachable to the distal attachment end for each of the one or more robotic arm assemblies and where the one or more robotic arm assembly milling tools are configured to machine process a work piece and the one or more robotic arm assembly milling tools are configured to adapt to an oscillation or apply an oscillation of the work piece during the machine process, where the oscillation of either the work piece or the one or more robotic arm assembly milling tools comprises a synthesis oscillation or a waveform oscillation, linear motion, reciprocating motion, circular/orbital motion, Brownian motion, curvilinear motion along multiple axes, oscillatory motion, simultaneous motions (when two or more above listed motions acts simultaneously, vibratory motion, motion oscillation, wave form synthesis, wave manipulation, floating motion and/or a combination thereof, or any type of waveform created by a user or artificial intelligence or a combination of both.

2. The universal milling machine assembly tool of claim 1, further comprising one or more robotic arm assembly attachment tools, where the one or more robotic arm assembly attachment tools are interchangeably attachable to the distal attachment end for each of the one or more robotic arm assemblies, where the one or more robotic arm assembly attachment tools comprise at least one of a robotic arm attachment tool, a milling tool, an electrical discharge machining tool, a material printing tool, an absolute zero tolerance robotic holding arm tool, a welding attachment tool, a flat surface tool, a fastener assembly tool, a robotic hand, a humanoid-type robot hand to imitate a human hand adapted to operate a tool comprising a hammer, a drill, a shovel, a pickaxe, other hand tools, a steered vehicle, a construction vehicle, aerial vehicles, where the tool is configured to oscillate in a waveform or synthesis or a combination thereof, and further comprising a sensor to obtain zero tolerance, where the one or more robotic arm assembly attachment tools comprise a tip and a size for an intended purpose.

3. The universal milling machine assembly tool of claim 2, where at least one of the one or more robotic arm assembly attachment tools configured to machine process a work piece and the machining tool is configured to adapt to oscillation of the work piece during the machine process, where the oscillation of the work piece comprises a synthesis oscillation or a waveform oscillation, linear motion, reciprocating motion, circular/orbital motion, Brownian motion, curvilinear motion along multiple axes, oscillatory motion, simultaneous motions (when two or more above listed motions acts simultaneously, vibratory motion, motion oscillation, wave form synthesis, wave manipulation, floating motion and/or a combination thereof, or any type of waveform created by a user or artificial intelligence or a combination of both.

4. The universal milling machine assembly tool of claim 2, where the fastener assembly tool comprises a fastening device configured to apply a fastener to a work piece.

5. The universal milling machine assembly tool of claim 4, where the fastener comprises a screw, a nail, a rivet, glue, epoxy, solder or a combination thereof.

6. The universal milling machine assembly tool of claim 2, where more than one of the one or more robotic arm assembly attachment tools are attached to one of the one or more robotic arm assemblies.

7. An article of manufacturing, the article comprising:
a universal milling machine tool body frame;
a robotic arm assembly base attached to the tool body frame;
one or more robotic arm assembly base couplers positioned on the robotic arm assembly base;
one or more articulating robotic arm assemblies connected to the one or more robotic arm assembly base couplers, where the one or more robotic arm assemblies comprise:
an attachment end for each of the one or more robotic arm assemblies to the one or more robotic arm assembly base couplers;
one or more robotic arm assembly connecting rods connected to each other through one or more articulating joints along the one or more robotic arm assemblies;
an attachment end for each of the one or more robotic arm assemblies;
one or more interchangeable milling assembly attachment tools attachable to the attachment end for each of the one or more robotic arm assemblies; and
one or more workpiece holders,
where the one or more interchangeable milling assembly attachment tools and the one or more workpiece holders are configured to adapt to an oscillation comprising at least one of linear motion, reciprocating motion, circular/orbital motion, Brownian motion, curvilinear motion along multiple axes, oscillatory motion, simultaneous motions (when two or more above listed motions acts simultaneously, vibratory motion, motion oscillation, wave form synthesis, wave manipulation, floating motion and/or a combination thereof.

8. The article of claim 7, where the one or more interchangeable milling assembly attachment tools comprise at least one of a robotic arm attachment tool, a machining tool, a milling tool, a material printing tool, an absolute zero tolerance robotic holding arm tool, a welding attachment tool, a flat surface tool or a fastener assembly tool.

9. A method for machining a work piece by a universal milling machine assembly tool, the method comprising:
providing universal milling machine assembly tool, the universal milling machine assembly tool comprising one or more one or more articulating robotic arm assemblies, where the one or more one or more articulating robotic arm assemblies comprise one or more robotic arm assembly connecting rods connected to each other through one or more articulating joints along the one or more robotic arm assemblies; an attachment end for each of the one or more robotic arm assemblies, and one or more interchangeable milling machine assembly attachment tools attachable to the attachment end for each of the one or more robotic arm assemblies;
providing a work piece to be machined by the universal milling machine assembly tool; and
applying the one or more interchangeable milling machine assembly attachment tools to process the work piece.

10. The method of claim 9, where applying the one or more interchangeable milling machine assembly attachment tools comprises applying at least one of a robotic arm attachment tool, a machining tool, a milling tool, a material printing tool, an absolute zero tolerance robotic holding arm tool, a welding attachment tool, a flat surface tool or a fastener assembly tool.

11. The universal milling machine assembly tool of claim 1, where the one or more robotic arm assembly milling tools comprise a grinding tool.

12. The universal milling machine assembly tool of claim 1, further comprising an economic/financial manager application.

13. The universal milling machine assembly tool of claim 1, where the one or more robotic arm assemblies are self-cleaning.

14. The universal milling machine assembly tool of claim 2, further comprising a sander body having a motor and an oscillating arm;
a plurality of interchangeable frames for holding sandpaper, the frames being arranged and configured to be selectively coupled to the motor for creating a sanding motion in order to alternatively and selectably sand surfaces in two planes;
at least one detail sanding pad positioned on one of said frames, said frames each having a substantially flat lower surface which may be selectively covered with abrasive material and said sanding pad having a substantially pointed front portion bounded laterally by two vertically oriented surfaces having an included angle of less than 90 degrees, at least one of said two surfaces covered with an abrasive material;
where abrasive material may be positioned selectively on one or more of said two surfaces or said lower surface of said frame.
